(19) United States
(12) Patent Application Publication
(10) Pub. No.: US 2025/0164726 A1
(43) Pub. Date: May 22, 2025

(54) TELECOMMUNICATION ENCLOSURE WITH DENSE CONNECTOR PORT CONFIGURATION

(71) Applicant: CommScope Technologies LLC, Hickory, NC (US)

(72) Inventors: Danny Willy August VERHEYDEN, Gelrode (BE); Petr KRŠKA, Bucovice (CZ); Philippe COENEGRACHT, Hasselt (BE)

(73) Assignee: CommScope Technologies LLC, Hickory, NC (US)

(21) Appl. No.: 18/835,298

(22) PCT Filed: Feb. 1, 2023
(86) PCT No.: PCT/US2023/061794

§ 371 Date: Aug. 1, 2024

Related U.S. Application Data
(60) Provisional application No. 63/305,887, filed on Feb. 2, 2022.

(51) Int. Cl. G02B 6/44; G02B 6/38

(52) U.S. Cl. CPC G02B 6/4448; G02B 6/3897

(57) ABSTRACT

The present disclosure relates to enclosures (e.g., terminals) having multiple rows of connector ports at a first side of a housing of the enclosure. Release members for releasing connectors from the connector ports of first and second ones of the rows are all accessible from a second side of the housing of the enclosure.

### CROSS-REFERENCE TO RELATED APPLICATION

This application is being filed on Feb. 1, 2023, as a PCT International application and claims the benefit and priority to U.S. Patent Application No. 63/305,887, filed Feb. 2, 2022, the disclosure of which is hereby incorporated by reference in its entirety.

### TECHNICAL FIELD

The present disclosure relates generally to telecommunication equipment. More particularly, the present disclosure relates to telecommunication enclosures.

### BACKGROUND

Telecommunication systems typically employ a network of telecommunication cables capable of transmitting large volumes of data and voice signals over relatively long distances. The telecommunication cables can include fiber optic cables, electrical cables, and/or combinations of electrical and fiber optic cables. A typical telecommunication network also includes a plurality of telecommunication enclosures integrated throughout the network of telecommunication cables. The telecommunication cables are often terminated by connectors such as fiber optic connectors. The fiber optic connectors can include single-fiber fiber optic connectors and multiple-fiber fiber optic connectors. Fiber optic connectors are adapted for making de-mateable fiber optic connections between two optical fibers or between two sets of optical fibers. Fiber optic connectors are often coupled together via fiber optic adapters, but certain fiber optic connectors can be directly coupled together without the use of fiber optic adapters.

One example type of enclosure frequently used in a telecommunication system is a multi-service terminal (MST). A multi-service terminal is frequently used near the outer edge of a telecommunication network to provide optical connection points for coupling subscribers to the network via drop cables. A typical multi-service terminal includes a plurality of connector ports that are accessible from outside the terminal. Each of the connector ports is adapted for receiving a ruggedized fiber optic connector that terminates the end of a drop cable. The opposite end of the drop cable is often connected to a subscriber location to connect the subscriber location to the telecommunication network. Example multi-service terminals are disclosed by U.S. Pat. Nos. 7,653,282; 7,397,997; 7,903,923; 7,489,849; and 7,512,304. Other terminals are disclosed by US Patent Application Publication Nos. 2020/0049922; 2020/0057223; 2020/0057224; and 2020/0057205.

### SUMMARY

One aspect of the present disclosure relates to enclosures (e.g., terminals) having multiple rows of connector ports wherein release members for releasing connectors from the connector ports of first and second ones of the rows are all accessible from the same direction.

In one example, the release members are all accessible from the same side of a housing of the enclosure.

In one example, the rows extend along a first dimension and are separated by a second dimension perpendicular to the first dimension, and the release members move in the second dimension.

In one example, at least some of the release members straddle connector ports of the first row to reach connector ports of the second row.

Another aspect of the present disclosure relates to a telecommunication enclosure including a housing. The housing includes a first side and an adjacent second side oriented at an angle relative to the first side. A first row of first connector ports is provided at the first side and a second row of second connector ports is provided at the first side. The second row of second connector ports is spaced from the first row of first connector ports such that the first row of first connector ports is positioned between the second row of second connector ports and the second side. The first and second connector ports are configured for receiving fiber optic connectors from outside the housing. First slide latches are provided for securing the fiber optic connectors in the first connector ports and second slide latches are provided for securing the fiber optic connectors in the second connector ports. The first and second slide latches are movable between retaining positions in which the first and second slide latches are adapted to secure the fiber optic connectors in the first and second connector ports, respectively, and release positions in which the first and second slide latches allow the fiber optic connectors to be removed from the first and second connector ports, respectively. First latch actuation locations are provided at the second side for allowing the first slide latches to be manually moved from the retaining positions to the release positions and second latch actuation locations are provided at the second side for allowing the second latches to be manually moved from the retaining positions to the release positions.

A further aspect of the present disclosure relates to a telecommunication enclosure including a housing having a first side and an adjacent second side oriented at an angle relative to the first side. A first row of first connector ports is provided at the first side and a second row of second connector ports is provided at the first side. The second row of second connector ports is spaced from the first row of first connector ports such that the first row of first connector ports is positioned between the second row of second connector ports and the second side. The first and second connector ports are configured for receiving fiber optic connectors from outside the housing. The fiber optic connectors are latchable within the first and second connector ports. First connector release members are accessible at the second side that can be actuated to unlatch fiber optic connectors with respect to the first connector ports or to allow the fiber optic connectors to be unlatched with respect to the first connector ports. Second connector release members are accessible at the second side that can be actuated to unlatch the fiber optic connectors with respect to the second connector ports or to allow the fiber optic connectors to be unlatched with respect to the second connector ports.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a front, bottom perspective view of a telecommunication enclosure in accordance with the principles of the present disclosure.

FIG. 2 is a bottom view of the telecommunication enclosure of FIG. 1.

FIG. 3 is a cross-sectional view taken along section line 3-3 of FIG. 2.

FIG. 4 is an enlargement of a portion of FIG. 3.

FIG. 5 is a cross-sectional view cut through a first row of latch actuators of the telecommunication enclosure of FIG. 1.

FIG. 6 is a cross-sectional view cut through a second row of latch actuators of the telecommunication enclosure of FIG. 1.

FIG. 7 is a front, bottom perspective view of another telecommunication enclosure in accordance with the principles of the present disclosure.

FIG. 8 is a bottom view of the telecommunication enclosure of FIG. 7.

FIG. 9 is a front view of the telecommunication enclosure of FIG. 7.

FIG. 10 is a cross-sectional view taken along section line 10-10 of FIG. 9.

FIG. 11 is an enlargement of a portion of FIG. 10.

FIG. 12 is a front, bottom perspective view of a further telecommunication enclosure in accordance with the principles of the present disclosure.

FIG. 13 is a bottom view of the telecommunication enclosure of FIG. 12.

FIG. 14 is a top, front view of still another telecommunication enclosure in accordance with the principles of the present disclosure.

FIG. 15 depicts a hardened fiber optic connector and converter adapted for use with the telecommunication enclosure of FIG. 14.

FIG. 16 is a top view of the telecommunication enclosure of FIG. 14.

FIG. 17 is a cross-sectional view taken along section line 17-17 of FIG. 16.

FIG. 18 is a cross-sectional view taken along section line 18-18 of FIG. 16.

FIG. 19 is a cross-sectional view showing one of the connectors latched within one of the connector ports of the telecommunications enclosure of FIG. 14.

FIG. 20 is a cross-sectional view showing one of the connectors latched partially inserted into one of the connector ports of the telecommunication enclosure of FIG. 14.

FIG. 21 is cross-sectional view cut through one of the actuation buttons of the telecommunication enclosure of FIG. 14.

FIG. 22 depicts an interior of the telecommunication enclosure of FIG. 14.

FIG. 23 depicts a further telecommunication enclosure in accordance with the principles of the present disclosure.

### DETAILED DESCRIPTION

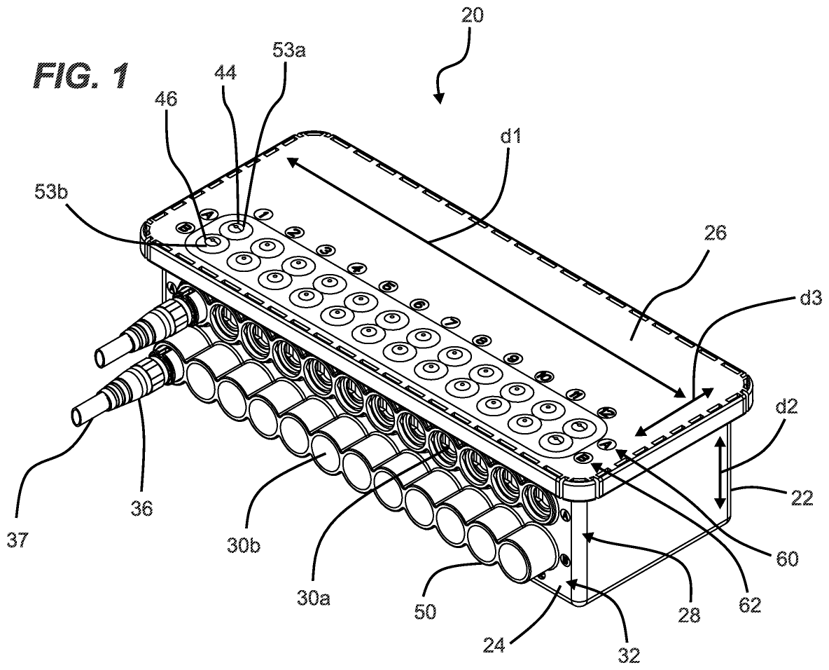

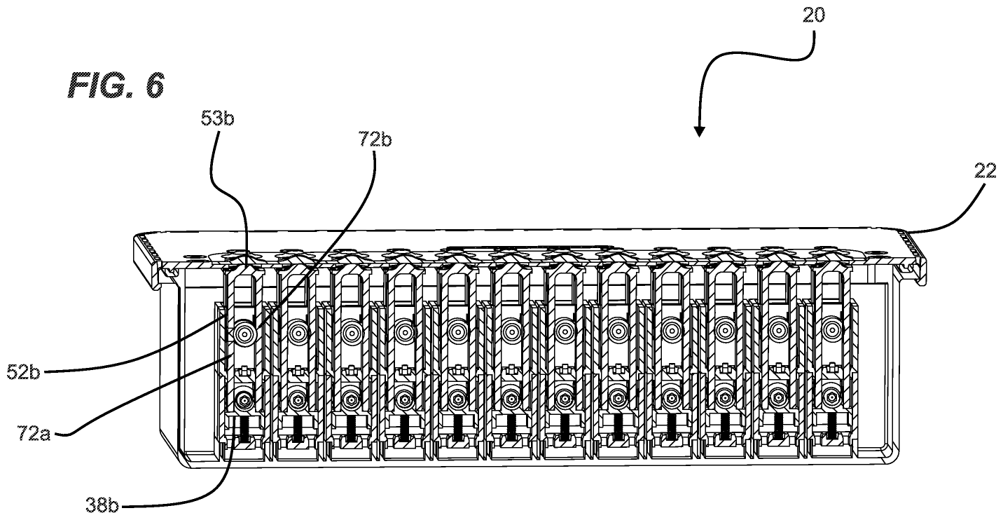

FIGS. 1-6 depict a telecommunication enclosure 20 (e.g., a terminal) in accordance with the principles of the present disclosure. In one example, the telecommunication enclosure 20 is environmentally sealed and rated for outdoor use. In one example, the telecommunication enclosure 20 includes a plurality of connector ports adapted for receiving connectors such as fiber optic connectors from outside the telecommunication enclosure 20. In certain examples, the telecommunication enclosure 20 can include alignment features such as ferrule alignment sleeves aligned (e.g., co-axially aligned) with the connector ports for optically connecting optical fibers corresponding to the fiber optic connectors inserted into the connector ports from outside the telecommunication enclosure 20 with optical fibers corresponding to fiber optic connectors located inside the telecommunication enclosure. The optical fibers corresponding to the fiber optic connectors located inside the telecommunication enclosure can be optically coupled to optical fibers of an input fiber optic cable. The optical fibers of the input optical cable can be routed into the enclosure 20 through a sealed cable pass-through location or the input optical cable can be connectorized and can be coupled to the enclosure 20 via an input connector port. In certain examples, an optical component such as a passive optical splitter, an optical tap and/or a wavelength division multiplexer can be included within the telecommunication enclosure. For example, an input fiber from the input cable can be coupled to an input of the optical component and optical fibers corresponding to the fiber optic connectors plugged into the connector ports on the inside of the enclosure can be coupled to outputs of the optical component. In certain examples, the fiber optic connectors from outside the telecommunication enclosure are sealed with respect to the telecommunication enclosure when inserted into the connector ports. The sealing can be provided by seals carried with the fiber optic connectors and/or by seals incorporated with the enclosure at the connector ports. In certain examples, the connector ports can be arranged in an array of connector ports including one, two, three, four or more rows of connector ports. The rows of connector ports can be parallel to one another. In one example, connector release structures corresponding to multiple rows of connector ports are accessible from one side of the telecommunication enclosure that is adjacent to a side of the enclosure at which the connector ports are located. When the connector release structures are actuated, the outside fiber optic connectors are capable of being removed from their corresponding connector ports. When connector release structures are not actuated, the outside fiber optic connectors are locked within their corresponding connector ports. With the fiber optic connectors locked within the connector ports, the fiber optic connectors are not intended to be removed from the connector ports absent releasing the connectors from the locked state via the connector release structures.

Referring to FIGS. 1-3, the telecommunication enclosure 20 includes a housing 22 including a first side 24 and an adjacent second side 26. The first and second sides 24, 26 are oriented at an angle relative to one another. As depicted, the first and second sides 24, 26 are perpendicular relative to one another, but in other examples the sides 24, 26 can be obliquely angled relative to one another. The telecommunication enclosure 20 includes a first row 28 of first connector ports 30a at the first side 24 of the housing 22, and also includes a second row 32 of second connector ports 30b at the first side 24 of the housing 22. The second row 32 of second connector ports 30b and the first row 28 of first connector ports 30a are spaced apart from one another and are parallel. The first and second rows 28, 32 are relatively positioned on the first side 24 of the housing 22 such that the first row 28 of first connector ports 30a is positioned between the second row 32 of second connector ports 30b and the second side 26 of the housing 22.

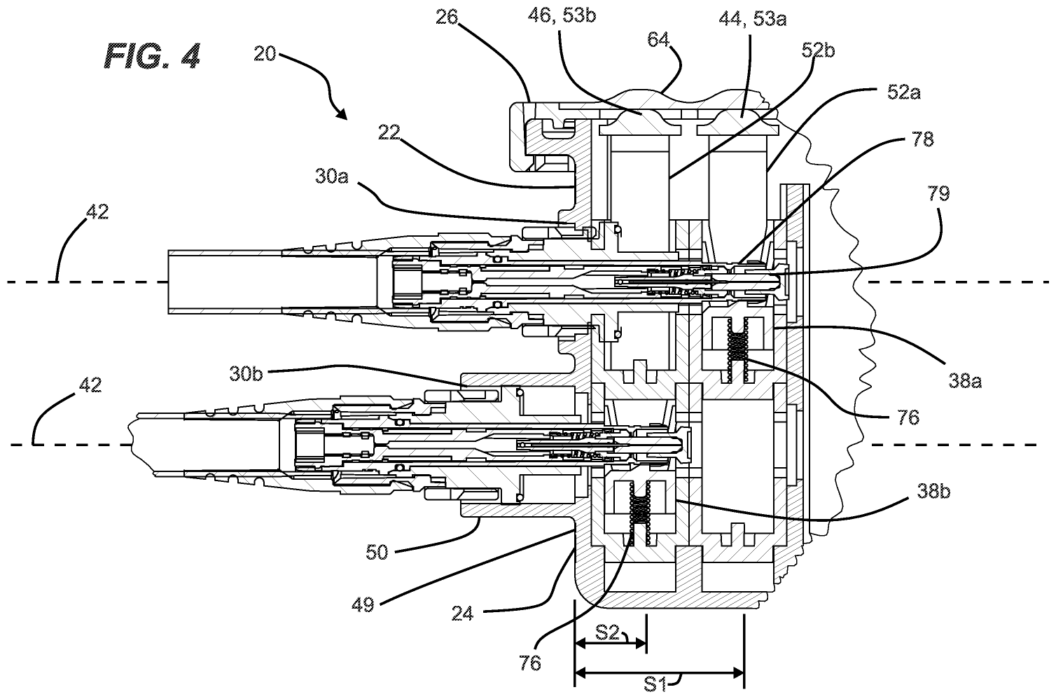

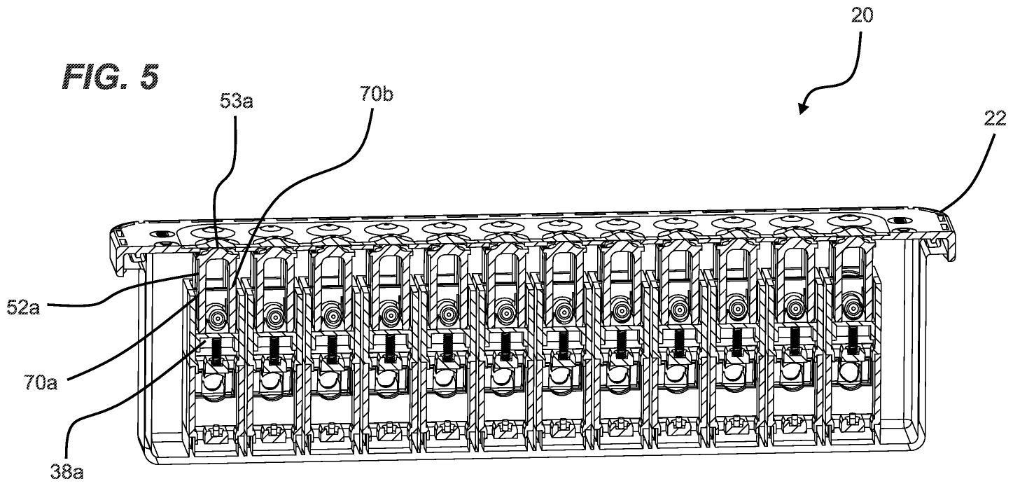

The first and second connector ports 30a, 30b are configured for receiving fiber optic connectors 36 (e.g., hardened/ruggedized fiber optic connectors mounted at the end of cables such as fiber optic drop cables 37 that can be routed to subscriber locations) from outside the housing 22. In the depicted example, the telecommunication enclosure 20 includes structure for securing (e.g., locking) the fiber optic connectors 36 within the first and second connector ports 30a, 30b. In one example, the structure can include latches incorporated as part of the telecommunication enclosure (e.g., mounted with respect to; carried with) housing 22. Referring to FIGS. 4-6, the depicted structure includes first slide latches 38a (see FIGS. 4 and 5) for securing the fiber optic connectors 36 in the first connector ports 30a and second slide latches 38b for securing the fiber optic connectors 36 in the second connector ports 30b. The first and second slide latches 38a, 38b are movable between connector retaining positions and connector release positions. In one example, the first and second slide latches 38a, 38b are mounted to slide relative to the housing 22 and relative to the connector ports 30a, 30b in a direction perpendicular to axes 42 of the connector ports 30a, 30b. During insertion and removal of the fiber optic connectors with respect to the first and second connector ports 30a, 30b, the fiber optic connectors 36 are moved along the axes 42. When in the connector retaining positions, the first and second slide latches 38a, 38b are adapted to secure (e.g., lock) the fiber optic connectors 36 in the first and second connector ports 30a, 30b, respectively. When in the release positions, the first and second slide latches 38a, 38b are adapted to allow the fiber optic connectors 36 to be manually removed respectively from the first and second connector ports 30a, 30b, respectively. For example, with the first and second slide latches 38a, 38b in the release positions, the fiber optic connectors 36 can be manually pulled out of the connector ports 30a, 30b from outside the housing 22.

Referring again to FIG. 1, the telecommunication enclosure 20 further includes latch actuation locations for actuating the slide latches 38a, 38b from outside the housing 22. In one example, latch actuation locations for latches corresponding to all of the rows are provided at one side of the housing 22 with the side being other than the first side 24 of the housing 22. For example, telecommunication enclosure 20 can include first latch actuation locations 44 at the second side 26 of the housing 22 for allowing the first slide latches 38a to be manually moved from the retaining positions to the release positions. The telecommunication enclosure 20 also includes second latch actuation locations 46 at the second side 26 of the housing 22 for allowing the second slide latches 38b to be manually moved from the retaining positions to the release positions.

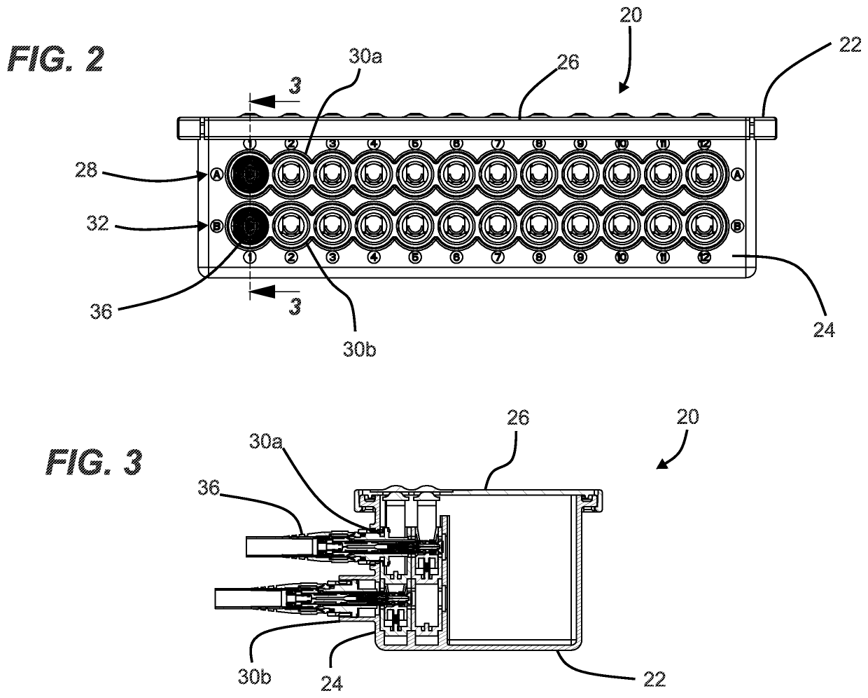

In one example, the first slide latches 38a are positioned a first distance S1 inwardly from a main outer surface 49 of the first side 24 of the housing 22, and the second slide latches 38b are positioned a second distance S2 inwardly from the main outer surface 49 of the first side 24 of the housing 22. The second distance S2 is smaller than the first distance S1. In the depicted example, the second connector ports 30b are defined at least in part by sleeves 50 that project outwardly from the main outer surface 49 of the first side 24 of the housing. The sleeves 50 are configured to outwardly stagger outer ends of the second connector ports 30b with respect to outer ends of the first connector ports 30a. Each of the first connector ports 30a is positioned directly above a corresponding one of the second connector ports 30b. Thus, the first connector ports 30a are not staggered with respect to the second connector ports 30b when viewed from an orientation along the port axes 42 (see FIG. 2). As depicted, the array is a 12×2 array, but in other examples other counts of columns and rows can be provided.

As shown at FIGS. 4-6, the telecommunication enclosure 20 can include first latch actuators 52a for moving the first slide latches 38a from the retaining positions to the release positions and second latch actuators 52b for moving the second slide latches 38b from the retaining positions to the release positions. The first latch actuators 52a can be further inwardly offset from the main surface 49 of the first side 24 than the second latch actuators 52b. The first latch actuators 52a are accessible at the first latch actuation locations 44 at the second side 26 of the housing 22 and the second latch actuators 52b are accessible at the second latch actuation locations 46 at the second side 26 of the housing 22. The first latch actuators 52a include first buttons 53a (e.g., actuation buttons) at the first actuation locations 44 that can be depressed to move the first slide latches 38a from the retaining positions to the release positions. The second latch actuators 52b include second buttons 53b (e.g., actuation buttons) at the second actuation locations 46 that can be depressed to move the second slide latches 38b from the retaining positions to the release positions. The first buttons 53a are arranged in a first button row 60 and the second buttons 53b are arranged in a second button row 62. The first and second button rows 60, 62 are parallel to each other. The first and second button rows 60, 62 are also parallel to the first row 28 of first connector ports 30a and the second row 32 of second connector ports 30b. The second button row 62 is positioned closer to the first side 24 than the first button row 60. In the depicted example, a membrane 64 is positioned over the first buttons 53a and the second buttons 53b for providing sealing that prevents moisture from entering the housing 22 at the first latch actuation locations 44 and the second latch actuation locations 46.

In the depicted example, the first row 28 of first connector ports 30a, the second row 32 of second connector ports 30b, the first button row 60 and the second button row 62 extend along a first dimension d1. Also, the first row 28 of first connector ports 30a and the second row 32 of second connector ports 30b are separated from one another along a second dimension d2 that is perpendicular relative to the first dimension d1. Further, the first button row 60 and the second button row 62 are separated from one another along the third dimension d3 that is perpendicular relative to the first and second dimensions d1, d2. The first slide latches 38a and the second slide latches 38b are configured to slide along the second dimension d2 and are spring biased toward the retaining positions.

In one example, the first latch actuators 52a each include first and second spaced-apart legs 70a, 70b coupled to the first buttons 53a for transferring force from the first buttons 53a to the first slide latches 38a for moving the first slide latches 38a from the retaining positions to the release positions. The first and second spaced-apart legs 70a, 70b of each first latch actuator 52a are positioned to straddle a corresponding one of the first connector ports 28.

In one example, the second latch actuators 52b each include first and second spaced-apart legs 72a, 72b coupled to the second buttons 53b for transferring force from the second buttons 53b to the second slide latches 38b for moving the second slide latches 38b from the retaining positions to the release positions. The first and second spaced-apart legs 72a, 72b of each second latch actuator 52b are position to straddle a corresponding one of the first connector ports 28 and a corresponding one of the second connector ports 32. The first and second spaced-apart legs 72a, 72b of the second latch actuators 52b are longer than the first and second spaced-apart legs 70a, 70b of the first latch actuators 52a. The slide latches 38a, 38b are spring biased toward the retaining positions by springs 76. Thus, movement of the slide latches 38a, 38b from the retaining positions toward the release positions is against the bias of the springs 76.

In certain examples, the fiber optic connectors 36 can include connector bodies 78 having front ends at which ferrules 79 are positioned and accessible. The ferrules 79 can support optical fibers of the drop cables. In certain examples, the ferrules can be received within ferrule alignment sleeves co-axially aligned with the connector ports when the connectors 36 are inserted in the connector ports. In certain examples, the connectors 36 (e.g., the connector bodies of the connectors 36) can include latch engagement features (e.g., latch receivers, latching shoulders, stops, etc.) adapted to oppose and engage the latches when the fiber optic connectors 36 are secured within the connector ports to prevent the fiber optic connectors from being withdrawn axially from the connector ports when secured within the connector ports. In some examples, the latches and/or the connector bodies can include ramp structures that force the latches, against the spring bias, from the retaining positions to the release positions as the fiber optic connectors are inserted in the connector ports. During the connector insertion process, once the latch engagement features on the connectors move inwardly past the latches, the spring bias applied to the latches moves the latches back to the retaining position thereby capturing and locking the fiber optic connectors within the connector ports (e.g., via mechanical interference/opposition between latches and the latch engagement features). To remove the fiber optic connectors from the connector ports, the latches are manually actuated (e.g., depressed) to move the latches from the retaining positions to the release positions. Once in the release positions, the latches no longer interfere with the latch engagement features to such a degree that the fiber optic connectors cannot be manually pulled from their corresponding connector ports. Hence, with the latches held in the release positions through actuation of the latch actuators, the fiber optic connectors can be manually pulled from their corresponding connector ports.

In the depicted example of FIGS. 1-6, the telecommunication enclosure is configured to be mounted to another structure (e.g., a wall, pole, etc.) with the first side 24 being a bottom side of the housing 22 and the second side 26 being a front of the housing 22. In other examples, the first side at which the connector ports are provided could be a left, right or top side of the housing. In still other examples, the first side at which the connector ports are provided can be a front side of the housing and the second side at which the actuation locations are provided can be a top, bottom, left or right side of the housing.

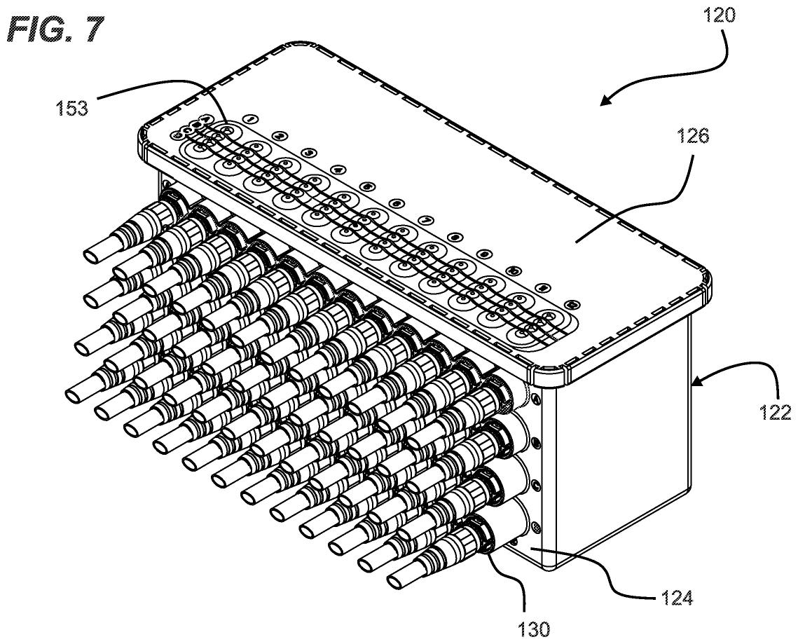

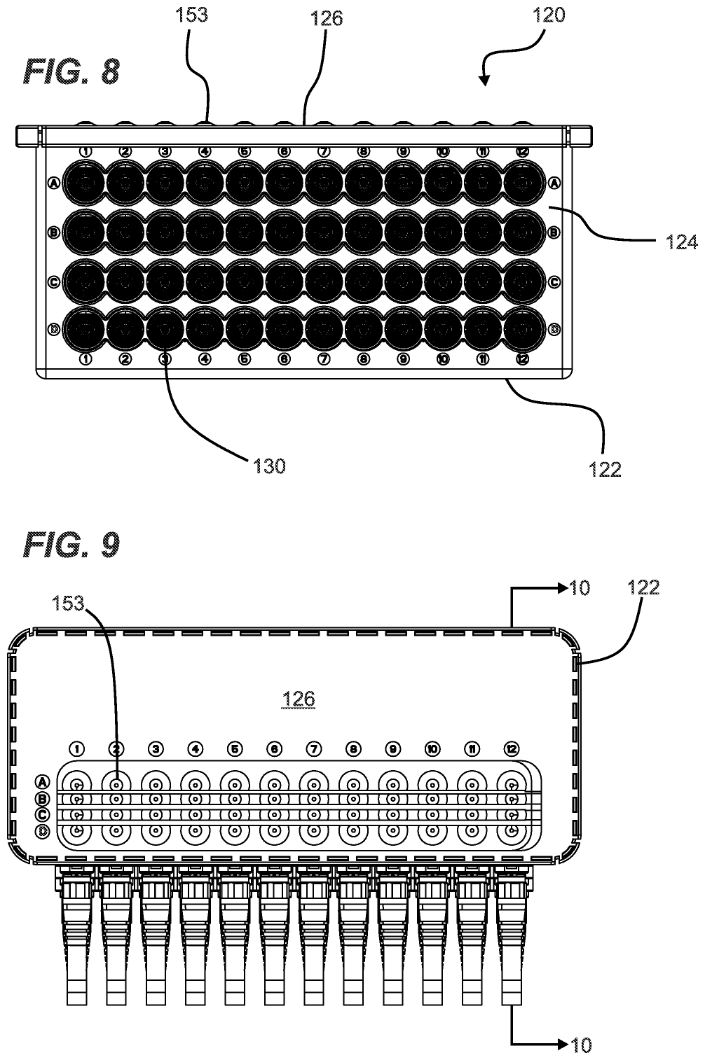

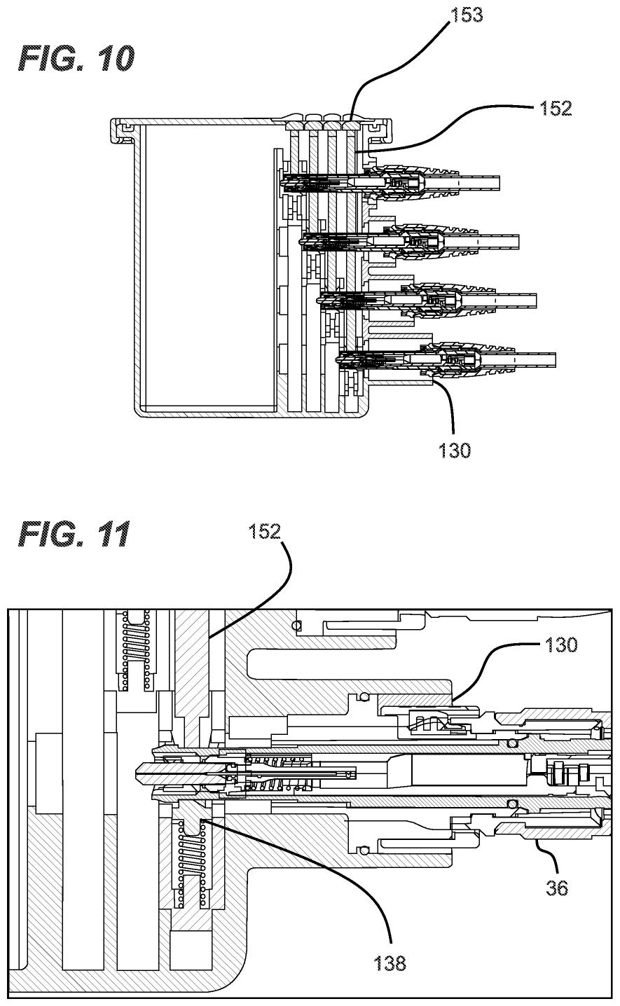

FIGS. 7-11 depict another telecommunication enclosure 120 in accordance with the principles of the present disclosure. The telecommunication enclosure 120 has the same components and configuration as the telecommunication enclosure 20 except the telecommunication enclosure 120 includes more than 2 rows of connector ports and includes rows of latches and latch actuators corresponding to each row of connector ports. In the depicted example, the telecommunication enclosure 120 includes connector ports 130 arranged in a 4-row array (see rows A-D) at a first side 124 of a housing 122 of the telecommunications enclosure 120. Outer ends of the connector ports are staggered with the staggering provided by connector port sleeves having different lengths. The lengths of the sleeves progressively increase with each row that is positioned progressively further from a second side 126 of the housing 122 that is adjacent to the first side 124 of the housing 122. Rows of buttons 153 (see rows A-D) are provided at the second side 126 of the housing 122. The buttons 153 are coupled to latch actuators 152 for actuating latches 138 corresponding to the connector ports 130 from connector retaining to connector release positions. Each row of buttons 153 corresponds to one of the rows of connector ports 130. For example, the connector and button rows assigned “A” correspond to one another, the connector and button rows assigned “B” correspond to one another, the connector and button rows assigned “C” correspond to one another, and the connector and button rows assigned “D” correspond to one another.

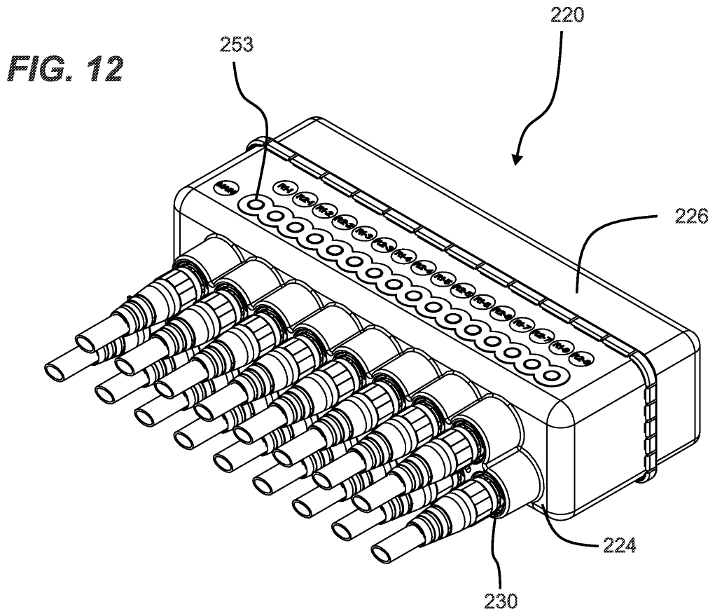

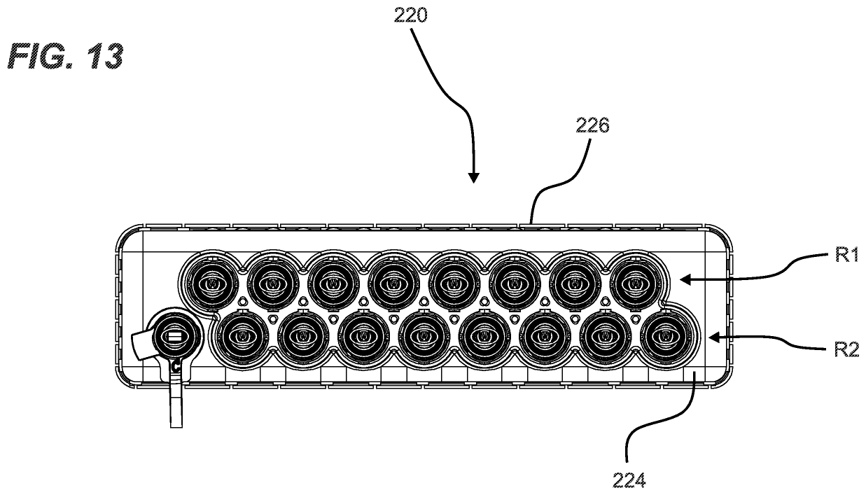

FIGS. 12 and 13 depict another telecommunication enclosure 220 in accordance with the principles of the present disclosure. The telecommunication enclosure includes 2 rows (R1, R2) of connector ports 230 provided at a first side 224 of a housing 222 of the telecommunication enclosure 220 and one row of buttons 253 provided at a second side 226 of the housing 222 of the telecommunication enclosure 220. The first and second sides 224, 226 of the housing 222 are adjacent sides. The buttons 253 are adapted to actuate latch actuators when depressed. The latch actuators, actuatable by the buttons 253, include latch actuators corresponding to the first row R1 of the connector ports 230 and second latch actuators corresponding to the second row R2 of connector ports 230. The connector ports 230 of the first row R1 are staggered relative to the connector ports 230 of the second row R2 when viewed in the direction of the connector port axes as shown at FIG. 13. In one example, the connector ports 230 of the first row R1 are aligned directly above gaps between the connector ports 230 of the second row R2. Latch actuators for actuating latches corresponding to the second row R2 can extend from the buttons 253 between the connector ports 232 of the first row R1 to reach the latches of the connector ports 232 of the second row R2.

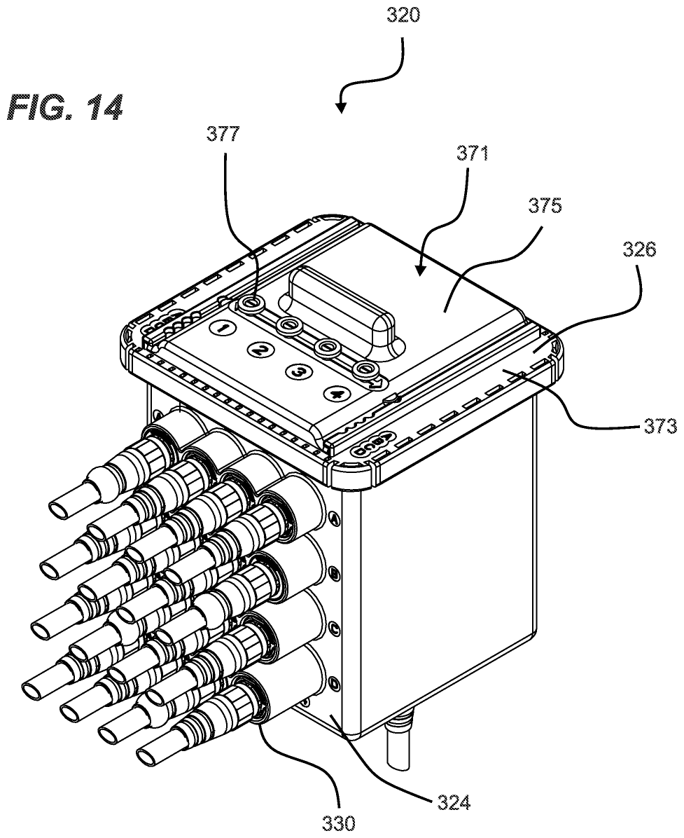

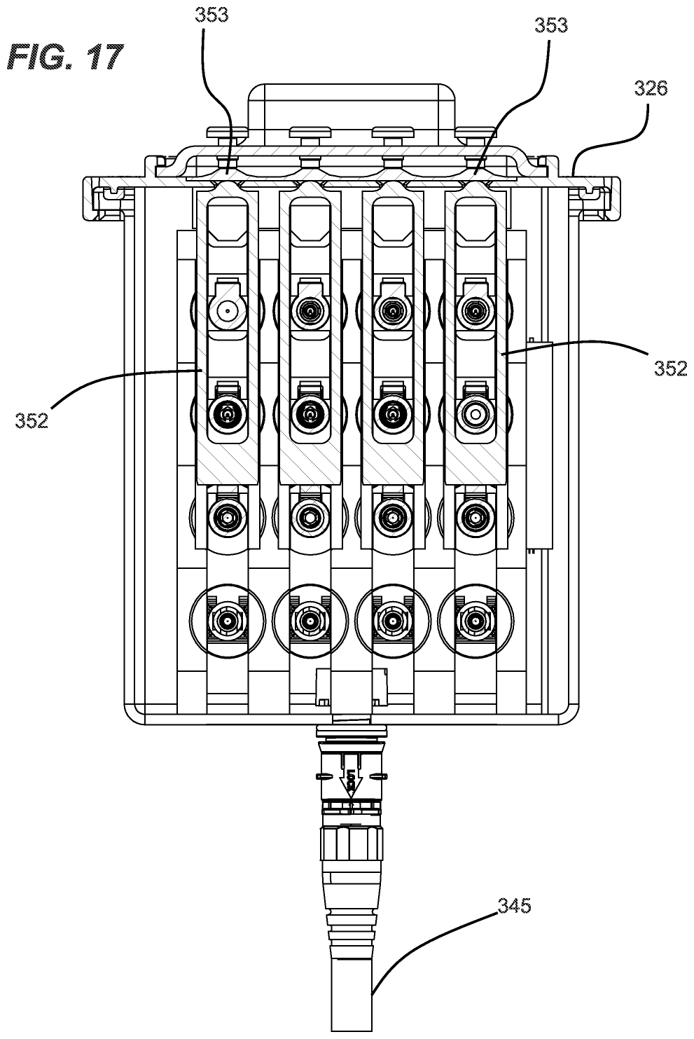

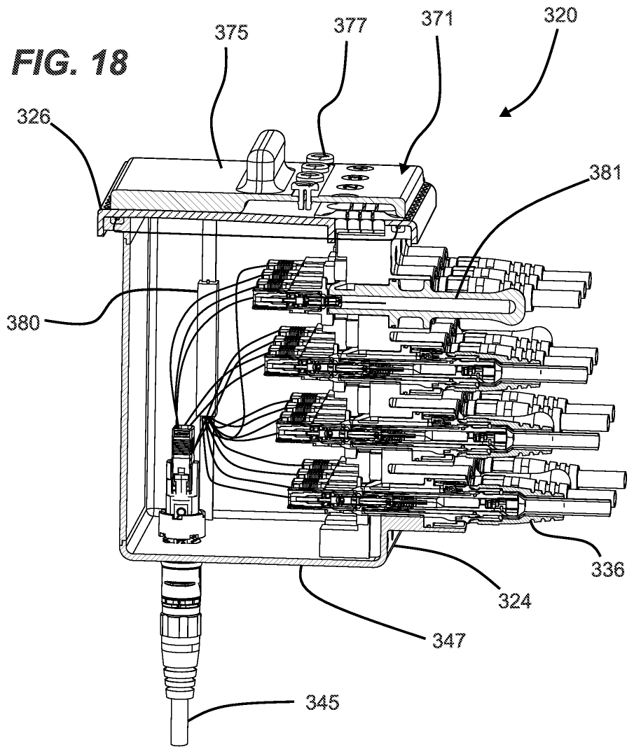

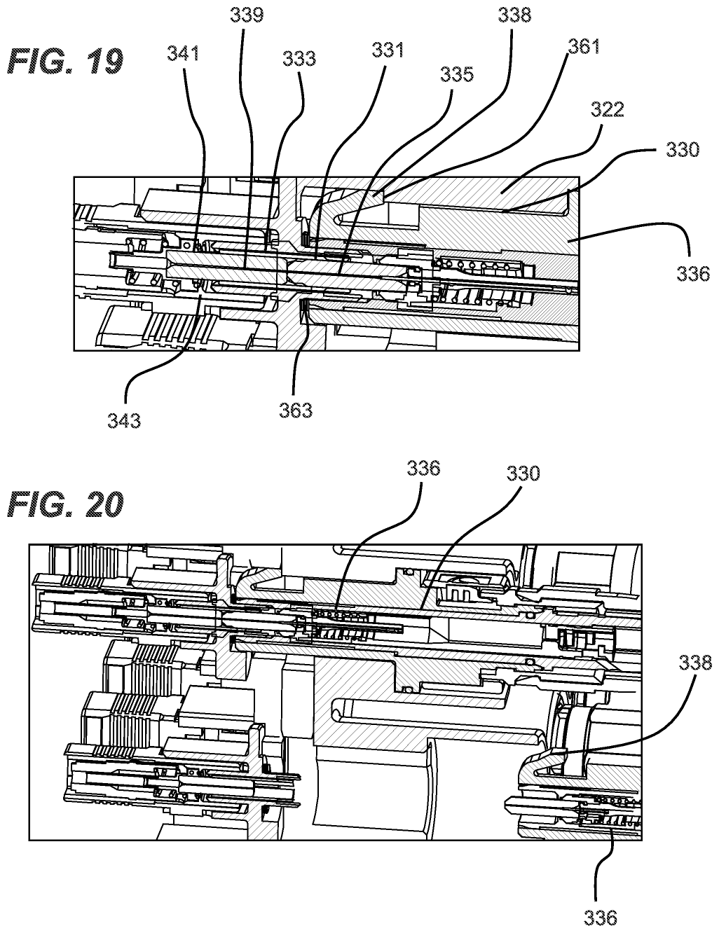

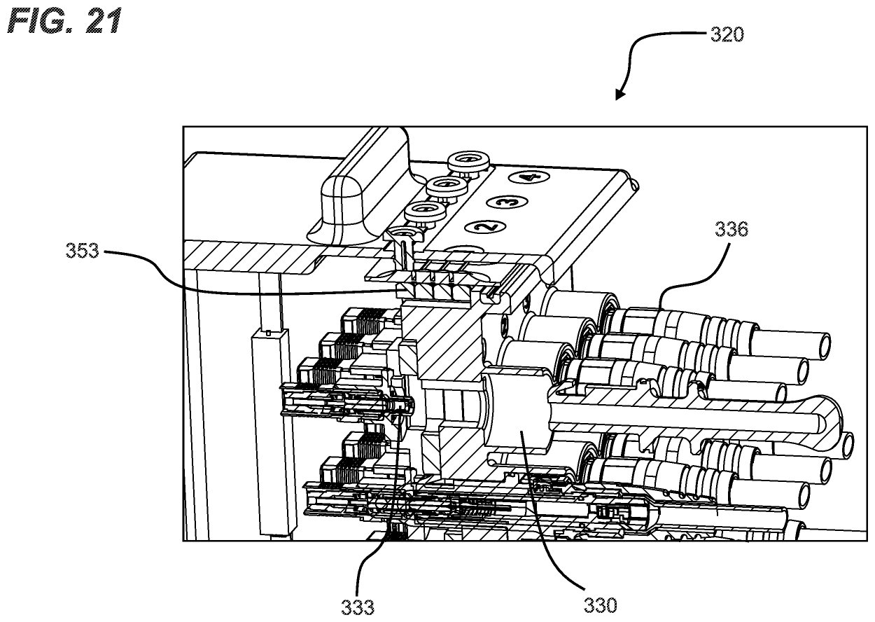

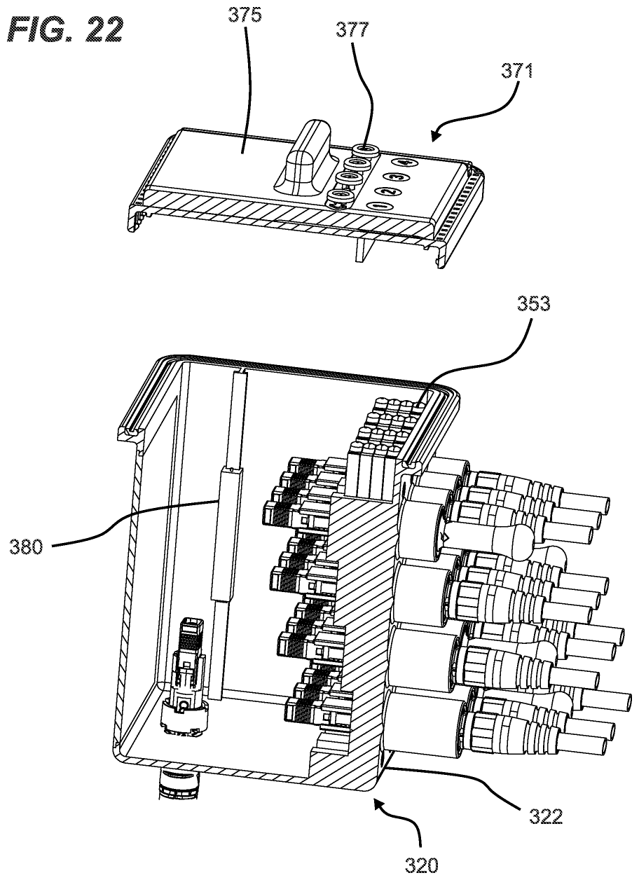

FIGS. 14 and 16-22 depict another telecommunication enclosure 320 in accordance with the principles of the present disclosure. The telecommunication enclosure 320 includes connector ports 330 arranged in parallel rows (A-D) at a first side 324 (e.g., a front side) of a housing 322 of the telecommunication enclosure 320. Parallel rows (A-D) of buttons 353 are provided at a second side 326 (e.g., a top side) of the housing 322 of the telecommunication enclosure 320. The first and second sides 324, 326 of the housing 322 are adjacent sides. The buttons 353 are adapted to actuate latch actuators 352 when depressed. At least some of the latch actuators 352 have a bifurcated configuration (e.g., see FIG. 17). Each row of buttons (A-D) corresponds to the latch actuators 352 of one of the rows of connector ports 330. Exterior connectors 336 are adapted to be latched in the connector ports 330. When latched in the connector ports 330 (see FIGS. 18-20), ferrules 331 of the connectors 336 are received within ferrule alignment sleeves 333 aligned with the connector ports 330 such that optical fibers 335 supported by the ferrules 331 are co-axially aligned with and coupled to optical fibers 339 of ferrules 341 received within the ferrule alignment sleeves 333 from inside the housing 322. The ferrules 341 correspond to fiber optic connectors 343 installed at the connector ports 330 from inside the housing 322. The fibers 339 can be directly coupled to optical fibers of an input cable 345 or can be indirectly coupled to an optical fiber or fibers of the input cable 345 through an intermediate telecommunication optical component 380 such as a passive optical splitter, an optical tap or a wavelength division multiplexer. The optical component can be mounted on a rail or other mounting structure within the housing 322. The input cable 345 is depicted accessing the interior of the housing 322 through a bottom 347 of the housing 322 (see FIG. 22). As depicted, the input cable 345 is connectorized and accesses the interior of the housing 322 through a de-mateable, sealed connectorized interface. In other examples, the cable 345 can access the interior of the housing though a sealed cable pass-through location. Dust plugs 381 can also be latched within the connector ports 330 for sealing the connector ports 330 when the connector ports 330 are unoccupied by exterior fiber optic connectors.

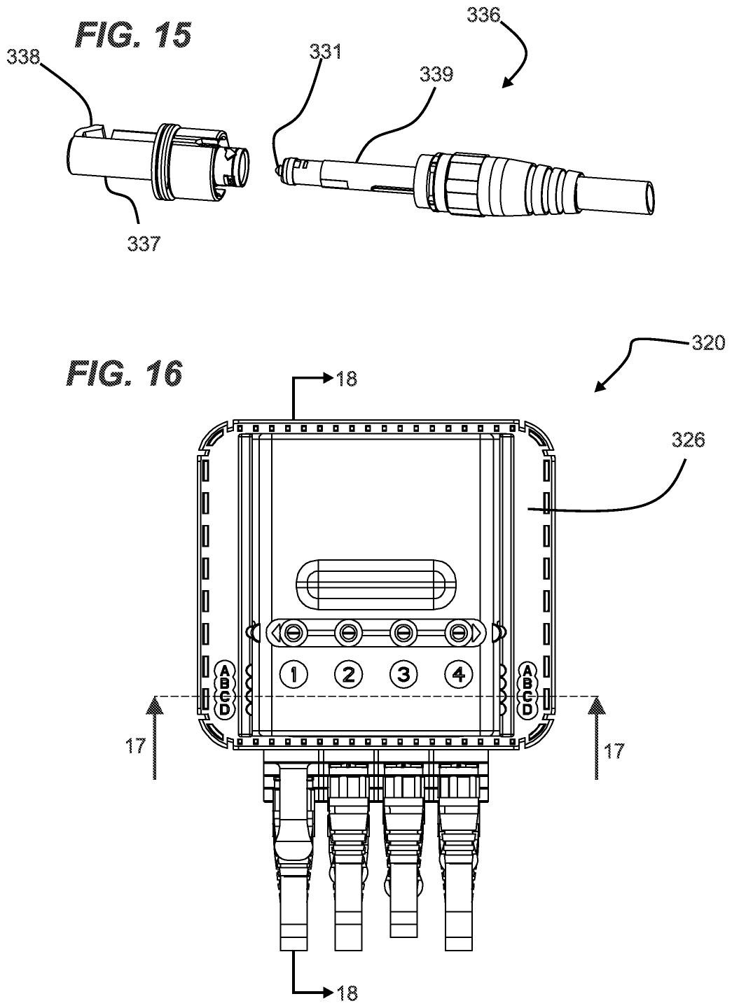

In previous examples disclosed herein, active latching features (e.g., slide latches) for latching outside connectors in the exterior connector ports have been incorporated as part of the enclosure and are adapted to engage non-active engagement features of the fiber optic connectors to provide connector retention in the connector ports. In contrast, the connector ports 330 of the enclosure 320 include inactive (e.g., stationary, fixed, etc.) latching features adapted to engage active latching features provided as part of the fiber optic connectors. In one example, the inactive latching features are stops such as shoulders, and the active latching features are movable latches such as resilient latches (e.g., resilient cantilever type latches). As shown at FIG. 15, the depicted fiber optic connector 336 includes a resilient cantilever latch 338 adjacent a front end of the connector 336. The latch 336 includes a base end that is unitary with a main body of a converter 337 that mounts over a connector body 339 of the connector 336. The connector body 339 includes a front end at which the ferrule 331 is supported and adapted for insertion into the ferrule alignment sleeve 333. The housing 322 includes shoulders defining stops 361 at each of the connector ports 330. When the connector 336 is inserted into one of the connector ports 330, the latch 338 is resiliently deformed to a release position via contact with structure defining the connector port 330. During insertion of the connector 336 into the port 330, once a free end of the latch 338 moves past the stop 361, the latch resiliently moves back to a retaining position in which the free end opposes the stop 361 to prevent the connector 336 from being withdrawn from the port 330. To release the connector 336 from the port 330, the button 353 of the latch actuator 352 corresponding to the connector port 330 is manually depressed causing the latch actuator to depress the latch 338 from the retaining position to the release position. With the latch 338 held in the release position by the latch actuator 352, the connector 336 can be withdrawn from the port 330. In one example, a spring 363 is positioned at the port 330 for forcing (e.g., ejecting) the connector 336 axially outwardly from the port 330 when the latch 339 is depressed. When the connector 336 is latched in the port 330, the spring 336 biases the connector 336 axially outwardly such that the free end of the latch 338 is forced into contact with the stop 361.

Referring to FIGS. 16-18, 21 and 22, the housing 322 includes a row selector 371 slidably mounted on a main body 373 of the housing 322. The row selector 371 is being movable to a first position, a second position, a third position, a fourth position and a fifth position. The row selector 371 blocks access to button rows A-D when in the first position to prevent any of the buttons 353 from being unintentionally depressed. The row selector 371 allows access to the buttons of button row A but blocks access to the buttons of button rows B-D when in the second position. The row selector 371 allows access to the buttons of button row B but blocks access to the buttons of button rows A, C and D when in the third position. The row selector 371 allows access to the buttons of button row C but blocks access to the buttons of button rows A, B and D when in the fourth position. The row selector 371 allows access to the buttons of button row D but blocks access to the buttons of button rows A-C when in the fifth position.

The row selector 371 includes a selector panel 375 carrying a single row of selector buttons 377. The selector panel 375 is movable (e.g., slidable) relative to the main body 373 of the housing 322 to move the row selector 371 between the different selector positions. When the row selector 371 is in the first position the selector panel 375 is positioned such that the selector buttons 377 are offset from the buttons of all of the button rows A-D. When the row selector 371 is in the second position the selector panel is positioned such that the selector buttons align with the buttons 353 of button row A. When the row selector 371 is in the third position the selector panel is positioned such that the selector buttons align with the buttons 353 of button row B. When the row selector 371 is in the fourth position the selector panel is positioned such that the selector buttons align with the buttons 353 of button row C. When the row selector 371 is in the fifth position the selector panel is positioned such that the selector buttons align with the buttons 353 of button row D.

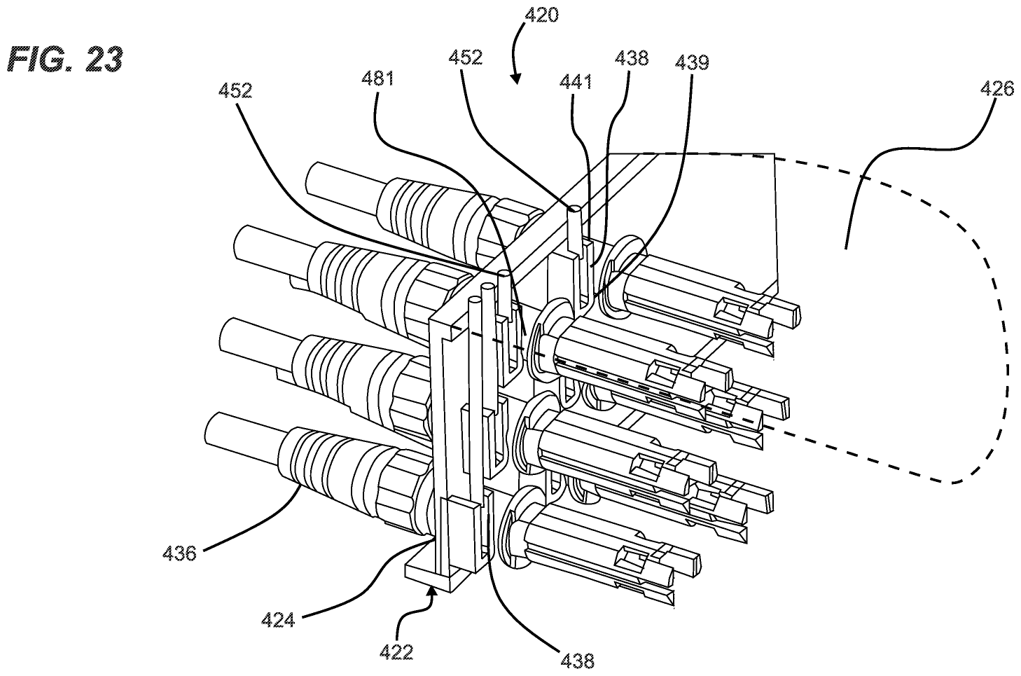

FIG. 23 schematically depicts portions of another telecommunication enclosure 420 in accordance with the principles of the present disclosure. The telecommunication enclosure 420 includes connector ports arranged in parallel rows at a first side 424 of a housing 422 of the telecommunication enclosure 420. Latches 438 integrated with the wall of the first side 424 of the housing 422 are provided for retaining fiber optic connectors 436 in the connector ports. The latches are flexible cantilever latches each having a base end 439 unitary with the housing wall and a free end 441. The latches 438 are biased, by their own inherent resiliency, toward connector retaining positions in which the latches engage stops 481 on the connectors 436 to prevent the connectors 436 from being removed from the connector ports. Latch releases 452 are accessible through a second side 426 of the housing 422. The latch releases can be sealed at the second side 426. When the latch releases 452 are in locking positions, the latch releases 452 oppose the latches 438 to prevent the latches from flexing away from the connectors to move from the connector retaining positions to the connector release positions. When the latch releases 452 are moved to non-locking positions (e.g., pulled upwardly from the second side 426 of the housing away from contact with the latches 438), the latch releases 452 no longer oppose the latches 438 such that the latches are not prevented from flexing from the connector retaining positions to the connector release positions. Ramp surfaces can be provided on the connectors 436 or on the latches 438 for providing a camming action that drives movement of the latches 438 from the retaining position to the release position when the connectors 436 are inserted into or pulled from the connector ports. Such movement is only permitted when the latch releases are in non-locking positions (e.g., pulled upwardly away from the latches 438 so as to not restrict movement of the latches 438 away from the connectors). When the latch releases 452 are in the locking positions (e.g., the lower positions), contact between the latch releases 452 and the latches 438 prevents the latches from flexing away from the connectors despite the presence of the ramps. Hence, when the latch releases 452 are in the locking positions, the latches 438 prevent insertion of the connectors 436 into the ports and also prevent removable of the connectors 436 from the ports. When the latch releases 452 are in the non-locking positions, the ramp surfaces cause the latches 438 to flex from the retaining position to the release position during insertion of the connectors 436 into the ports. Once the stops 481 move inwardly past the latches during connector insertion, the latches 438 automatically snap back from the release positions to the retaining positions. Thereafter, the latch releases 452 moved to the locking positions to lock the latches in the retaining positions. To remove the connectors from the ports, the latch releases are moved to the non-locking positions so as to not restrict movement of the latches 438 from the retaining positions to the release positions. With the latch releases in the non-locking positions, the connectors 436 can be removed from the ports by pulling on the connectors such that ramp surfaces cam the latches 438 from the retaining positions to the release positions thereby allowing withdrawal of the connectors from the ports.

Certain aspects of the present disclosure relate to terminals having multiple rows of outside accessible connector ports having latch actuators that all can be accessed from one side of the terminal. It will be appreciated that aspects of the present disclosure are also applicable to examples having single rows of outside accessible connector ports and are also applicable to outside accessible connector ports in general having features of the type disclosed herein. The aspects also relate to fiber optic connector and connector port systems regardless of whether the ports are arranged in rows.

1. A telecommunication enclosure comprising:
a housing including a first side and an adjacent second side oriented at an angle relative to the first side;
a first row of first connector ports provided at the first side;
a second row of second connector ports provided at the first side, the second row of second connector ports being spaced from the first row of first connector ports such that the first row of first connector ports is positioned between the second row of second connector ports and the second side;
the first and second connector ports being configured for receiving fiber optic connectors from outside the housing;
first slide latches for securing the fiber optic connectors in the first connector ports;
second slide latches for securing the fiber optic connectors in the second connector ports;
the first and second slide latches being movable between retaining positions in which the first and second slide latches are adapted to secure the fiber optic connectors in the first and second connector ports, respectively, and release positions in which the first and second slide latches allow the fiber optic connectors to be removed from the first and second connector ports, respectively;
first latch actuation locations at the second side for allowing the first slide latches to be manually moved from the retaining positions to the release positions; and
second latch actuation locations at the second side for allowing the second slide latches to be manually moved from the retaining positions to the release positions.

2. The telecommunication enclosure of claim 1, wherein the first slide latches are positioned a first distance inwardly from the first side and the second slide latches are positioned a second distance inwardly from the first side, the second distance being larger than the first distance.

3. The telecommunication enclosure of claim 1, wherein the first and second latch actuation locations respectively include first actuation buttons and second actuation buttons.

4. The telecommunication enclosure of claim 3, wherein the first actuation buttons are arranged in a first button row and the second actuation buttons are arranged in a second button row, the first and second button rows being parallel to the first row of first connector ports and the second row of second connector ports.

5. The telecommunication enclosure of claim 2, further comprising first latch actuators for moving the first slide latches from the retaining positions to the release positions and second latch actuators for moving the second slide latches from the retaining positions to the release positions, the first latch actuators being accessible at the first latch actuation locations and the second latch actuators being accessible at the second latch actuation locations.

6. The telecommunication enclosure of claim 5, wherein the first latch actuators include first buttons at the first actuation locations that can be depressed to move the first slide latches from the retaining positions to the release positions, and the second latch actuators include second buttons at the second actuation locations that can be depressed to move the second slide latches from the retaining positions to the release positions.

7. The telecommunication device of claim 6, further comprising a membrane positioned over the first buttons and the second buttons for providing sealing that prevents moisture from entering the housing at the first latch actuation locations and the second latch actuation locations.

8. The telecommunication device of claim 6, wherein the first latch actuators each include first and second spaced-apart legs coupled to the first buttons for transferring force from the first buttons to the first slide latches for moving the first slide latches from the retaining positions to the release positions, the first and second spaced-apart legs of each first latch actuator being positioned to straddle a corresponding one of the first connector ports.

9. The telecommunication device of claim 8, wherein the second latch actuators each include first and second spaced-apart legs coupled to the second buttons for transferring force from the second buttons to the second slide latches for moving the second slide latches from the retaining positions to the release positions, the first and second spaced-apart legs of each second latch actuator being positioned to straddle a corresponding one of the first connector ports and a corresponding one of the second connector ports, the first and second spaced-apart legs of the second latch actuators being longer than the first and second spaced-apart legs of the first latch actuators.

10. The telecommunication device of claim 9, wherein the first buttons are arranged in a first button row and the second buttons are arranged in a second button row, the first and second button rows being parallel to the first row of first connector ports and the second row of second connector ports.

11. The telecommunication device of claim 10, wherein the second button row is positioned closer to the first side than the first button row.

12. The telecommunication device of claim 1, wherein the second side of the housing is a front side of the housing.

13. The telecommunication device of claim 12, wherein the first side of the housing is a bottom side of the housing.

14. The telecommunication device of claim 1, wherein the first side of the housing is a front side of the housing.

15. The telecommunication device of claim 14, wherein the second side of the housing is a top side of the housing.

16. The telecommunication device of claim 10, wherein the first row of first connector ports, the second row of second connector ports, the first button row, and the second button row extend along a first dimension, wherein the first row of first connector ports and the second row of second connector ports are separated from one another along a second dimension that is perpendicular relative to the first dimension, and wherein the first button row and the second button row are separated from one another along a third dimension that is perpendicular relative to the first and second dimensions.

17. The telecommunication device of claim 1, wherein the first slide latches and the second slide latches are spring biased toward the retaining positions.

18. A telecommunication enclosure comprising:
a housing including a first side and an adjacent second side oriented at an angle relative to the first side;
a first row of first connector ports provided at the first side;
a second row of second connector ports provided at the first side, the second row of second connector ports being spaced from the first row of first connector ports such that the first row of first connector ports is positioned between the second row of second connector ports and the second side;
the first and second connector ports being configured for receiving fiber optic connectors from outside the housing, the fiber optic connectors being latchable within the first and second connector ports;
first connector release members accessible at the second side that can be actuated to unlatch the fiber optic connectors with respect to the first connector ports or to allow the fiber optic connectors to be unlatched with respect to the first connector ports; and
second connector release members accessible at the second side that can be actuated to unlatch the fiber optic connectors with respect to the second connector ports or to allow the fiber optic connectors to be unlatched with respect to the second connector ports.

19. The telecommunication enclosure of claim 18, wherein latches for latching the fiber optic connectors within the first connector ports and the second connector ports are provided on the fiber optic connectors.

20. The telecommunication enclosure of claim 18, wherein latches for latching the fiber optic connectors within the first connector ports and the second connector ports are included with the housing.

21. The telecommunication enclosure of claim 18, wherein the first connector release members are positioned a first distance inwardly from the first side and the second connector release members are positioned a second distance inwardly from the first side, the second distance being larger than the first distance.

22. The telecommunication enclosure of claim 18, wherein the first and second connector release members respectively include first actuation buttons and second actuation buttons accessible at the second side of the housing.

23. The telecommunication enclosure of claim 22, wherein the first actuation buttons are arranged in a first button row and the second actuation buttons are arranged in a second button row, the first and second button rows being parallel to the first row of first connector ports and the second row of second connector ports.

24. The telecommunication enclosure of claim 23, wherein the housing includes a row selector slidably mounted on a main body of the housing, the row selector being movable to a first position, a second position, and a third position, wherein the row selector blocks access to the first and second button rows when in the first position, wherein the row selector allows the first actuation buttons to be accessed and prevents the second actuation buttons from being accessed when in the second position, and wherein the row selector allows the second actuation buttons to be accessed and prevents the first actuation buttons from being accessed when in the third position.

25. The telecommunication enclosure of claim 24, wherein the row selector includes a selector panel carrying a single row of selector buttons, wherein when the row selector is in the first position, the selector panel is positioned such that the selector buttons are offset from the first and second button rows, wherein when the row selector is in the second position, the selector panel is positioned such that the selector buttons align with the first actuation buttons of the first button row, and wherein when the row selector is in the third position, the selector panel is positioned such that the selector buttons align with the second actuation buttons of the second button row.

26. The telecommunication enclosure of claim 18, wherein each of the second connector release members has a bifurcated configuration that straddles a corresponding one of the first connector ports.

27. The telecommunication enclosure of claim 18, further comprising springs for pushing the fiber optic connectors outwardly when the fiber optic connectors are unlatched from the first connector ports and the second connector ports.

28. The telecommunication enclosure of claim 20, wherein the latches are movable between latching positions and release positions, wherein the first and second release members are each actuatable between first positions and second positions, wherein when the first and second release members are in the first positions, the first and second release members each prevent a corresponding one of the latches from moving from the latching position to the release position, and wherein when the first and second release members are in the second positions, the first and second release members each allow a corresponding one of the latches to move from the latching position to the release position.

29. The telecommunication enclosure of claim 28, wherein the latches are unitarily formed with the housing and are biased by inherent elasticity of the latches toward the latching positions.
